(19) United States
(12) Patent Application Publication
(10) Pub. No.: US 2002/0124351 A1
(43) Pub. Date: Sep. 12, 2002

(54) Pre-loadable hinge assembly

(75) Inventors: David Lowry, Wayne, PA (US); Eugene Novin, Ambler, PA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: CEMA Technologies, Inc.

(21) Appl. No.: 10/047,947

(22) Filed: Jan. 14, 2002

Related U.S. Application Data
(60) Provisional application No. 60/261,481, filed on Jan. 12, 2001.

(51) Int. Cl. E05D 11/00

(52) U.S. Cl. 16/273

(57) ABSTRACT

A hinge assembly includes a friction element for being secured to a first member. The friction element has a generally cylindrical wall including a generally longitudinally extending face and an internal surface. A generally cylindrical pintle for being secured to the second member is positioned rotatably within the friction element and includes an external surface, the external surface and internal surface being configured to provide an interference fit therebetween such that the friction element applies a generally radially directed compressive force to the pintle. A protuberance extends generally radially outwardly from the pintle and engages the generally longitudinally extending face when the pintle and friction element achieve a first predefined angular relationship. Movement beyond the first predefined angular relationship to a second predefined angular relationship causes the first diameter to increase, thereby decreasing the compressive forces to the pintle and imparting a counter-rotational force to the pintle and friction element.

### CROSS-REFERENCE TO RELATED APPLICATIONS

This is a non-provisional application based on provisional patent application No. 60/261,481 filed Jan. 12, 2001.

### BACKGROUND OF THE INVENTION

The present invention relates generally to a hinge assembly for rotatably coupling a first member to a second member and, more particularly, to a hinge assembly having a pre-loadable friction element which controls and influences the angular position of the first member with respect to the second member.

It is often necessary to control the angular position of a first member which is rotatably coupled to a second member by a hinge. Such control is often economically and efficiently provided by employing one or more friction hinges. Friction hinges are well known and are disclosed in U.S. Pat. Nos. 5,491,874 and 5,752,293, which are incorporated herein by reference. Friction hinges are particularly well suited for “clamshell” devices such as laptop or notebook computers, personal digital assistants, and other hand-held devices having a similar two-part configuration where a cover or display screen rotates relative to a keyboard or the like. Friction hinges permit a user to position the display screen or cover relative to the keyboard, cover, etc. and maintain the relative rotational position of the two parts. In a laptop computer, for example, the display screen rotates from a closed position wherein the screen is in face-to-face mating engagement with the keyboard to an open position where the display screen is positioned generally within a range from about perpendicular to the keyboard to approximately one hundred thirty-five degrees with respect to the keyboard. In such a configuration the friction element of the hinge is normally structurally fastened to the base of the computer and the shaft is connected to the display screen. When the display screen is rotated, it is held in a desired angular position by the force generated between the friction element(s) in the hinge and the pintle or shaft.

Many other applications exist for such friction hinges. For example, in many automobiles of recent vintage a pivotable display screen is provided for viewing of pre-recorded video or for display of video games. Such display screens are often roof-mounted and rotate from a closed position wherein the display screen is generally parallel to the roof of the vehicle to an open position directed toward the viewer. Due to the variety of sizes of viewers and positions for viewing within the automobile it is often necessary to change the angle of the display screen with respect to a closed position. In such applications, friction hinges provide an inexpensive and convenient mechanism for maintaining the display screen in a desired orientation.

One drawback to standard friction hinges is that, in a given direction of rotation, such hinges apply generally uniform resisting force to movement of the halves relatively to one another. Thus, resistive force is applied to the halves by the hinge from the closed position to the full open position and vice-versa. The result of this, when one considers the closed position, is that the user must exert significant force to separate the two halves of the device. In other words, once a retaining latch or similar retention feature that maintains the two halves of the clamshell-type device in a closed position is released, the user must engage one or more fingers on what is usually a very small gripping feature and separate the two halves of the device against a significant resistive force applied by the friction hinge. This act can be difficult due to the friction built into the friction hinge and also due to the force of gravity where a cover or display panel must be rotated upwardly with respect to the lower half of the device, such as in a laptop or notebook computer.

The present invention overcomes many of the disadvantages inherent in the conventional friction hinge assembly by providing a friction hinge that reduces resistive forces in the hinge in what will generally be the closed position of a clamshell-type device, or at some other predetermined angular position between the friction element and the pintle or shaft. The present invention also overcomes such disadvantages by providing a multi-component pre-load that assists in urging the friction element and pintle or shaft from the predetermined angular position so as to, for example, assist in separating the halves of a clamshell-type device.

### BRIEF SUMMARY OF THE INVENTION

A hinge assembly for rotatably coupling a first member to a second member. The hinge assembly includes a friction element for being secured to the first member. The friction element has a generally cylindrical wall. The wall includes a generally longitudinally extending face and an internal surface defining a first diameter. The hinge assembly further includes a generally cylindrical pintle for being secured to the second member and positioned rotatably within the friction element. The pintle includes an external surface, the external surface defining a second diameter, the first and second diameters being configured to provide an interference fit therebetween such that the friction element applies a generally radially directed compressive force to the pintle. A protuberance extends generally radially outwardly from the pintle. The protuberance engages the generally longitudinally extending face when the pintle and friction element achieve a first predefined angular relationship with respect to one another, see claim 1. Movement beyond the first predefined angular relationship to a second predefined angular relationship between the friction member and pintle, see claim 1, causes the first diameter to increase, thereby decreasing the compressive forces to the pintle and imparting a counter-rotational force to the pintle and friction element for urging the pintle and friction element away from the second predefined angular relationship.

In a further embodiment, the hinge assembly includes a friction element for being secured to the first member. The friction element has a generally cylindrical wall. The wall includes a generally longitudinally extending face and an internal surface defining a first diameter. The hinge assembly further includes a generally cylindrical pintle for being secured to the second member and positioned rotatably within the friction element. The pintle includes an external surface, the external surface defining a second diameter, the first and second diameters being configured to provide an interference fit therebetween such that the friction element applies a generally radially directed compressive force to the pintle. A protuberance extends generally radially outwardly from the pintle. The protuberance engages the generally longitudinally extending face when the pintle and friction element achieve a first predefined angular relationship with respect to one another, see claim 1. Movement beyond the first predefined angular relationship to a second predefined angular relationship between the friction member and pintle, see claim 1, causes the first diameter to increase, thereby decreasing the compressive forces to the pintle and imparting a counter-rotational force to the pintle and friction element for urging the pintle and friction element away from the second predefined angular relationship. A torque arm extends from the friction element and is configured to be positioned on the first member. The torque arm deflects as the pintle and friction element move from the first to the second predefined angular relationship. The deflection provides a supplemental force for urging the pintle and friction element away from the second predefined angular relationship.

In yet a further embodiment, the hinge assembly includes a friction element for being secured to the first member. The friction element has a generally cylindrical wall. The wall has a generally longitudinally extending face and an internal surface defining a first diameter and an elongated, partial circumferential passage through wall. The hinge assembly further includes a generally cylindrical pintle for being secured to the second member and being rotatably positioned within the friction element. The pintle includes an external surface, the external surface defining a second diameter, the first and second diameters being configured to provide an interference fit therebetween such that the friction element applies a generally radially directed compressive force to the pintle. A protuberance extends generally radially outwardly from the pintle. The protuberance engages the generally longitudinally extending face when the pintle and friction element achieve a first predefined angular relationship with respect to one another, see claim 1. Movement beyond the first predefined angular relationship to a second predefined angular relationship between the friction member and pintle, see claim 1, causes the first diameter to increase, thereby decreasing the compressive forces to the pintle and imparting a counter-rotational force to the pintle and friction element for urging the pintle and friction element away from the second predefined angular relationship. The protuberance is positioned longitudinally on the pintle so as to be in longitudinal alignment and registry with the partial circumferential passage. The pintle and friction element are arranged so the protuberance extends through the partial circumferential passage through at least a portion of a rotational range of motion of the pintle with respect to the friction element. A torque arm extends from the friction element and is configured to be positioned on the first member. The torque arm deflects as the pintle and friction element move from the first to the second predefined angular relationship. The deflection provides a supplemental force for urging the pintle and friction element away from the second predefined angular relationship.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a front elevational view of a hinge assembly in accordance with the preferred embodiment of the present invention;

FIG. 2 is a cross-sectional view of the hinge assembly shown in FIG. 1, taken along lines 2-2 in FIG. 1 and showing a friction member and a pintle in a first predefined angular relationship;

FIG. 2b is a cross-sectional view of the hinge assembly shown in FIG. 1, taken along lines 2-2 in FIG. 1 and showing a friction member and a pintle in a second predefined angular relationship; and

FIG. 2c is a cross-sectional view of the hinge assembly shown in FIG. 1, taken along lines 2-2 in FIG. 1 and showing a friction member and a pintle in a third predefined angular relationship.

### DETAILED DESCRIPTION OF THE INVENTION

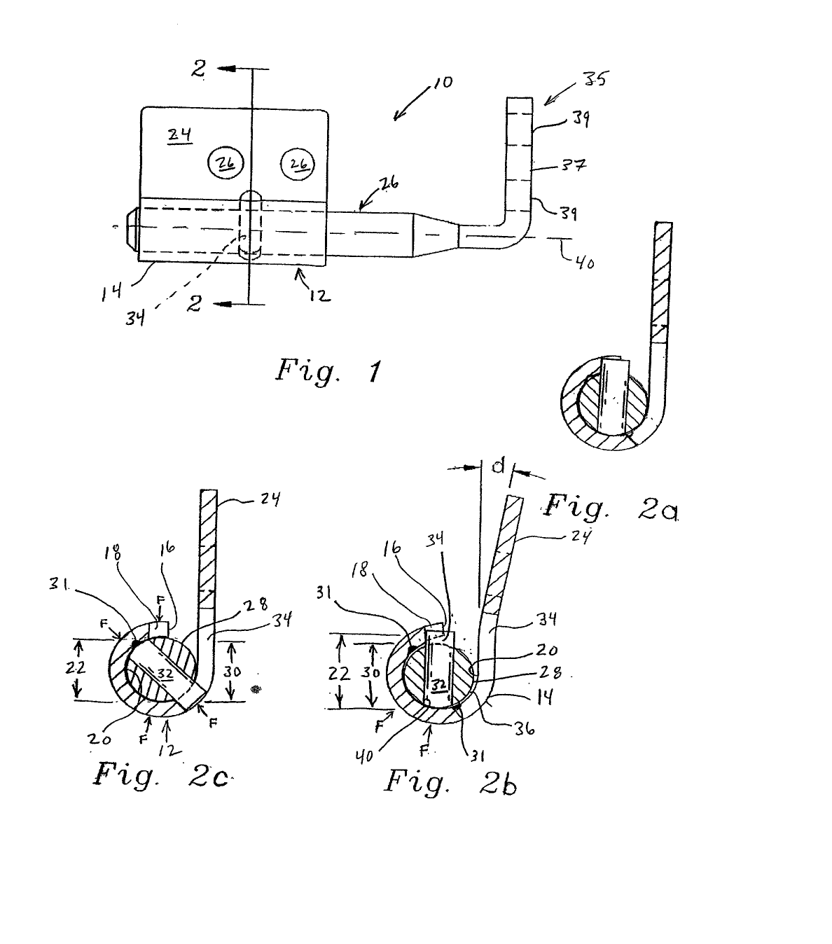

Referring to the drawings in detail, wherein like numerals indicate like elements throughout, there is shown in FIGS. 1 and 2a-2c a preferred embodiment of a pre-loadable hinge assembly, generally designated 10, for rotatably coupling a first member (not shown) to a second member (not shown) in accordance with the present invention. The present invention is not limited to rotatably coupling any particular type of first member to a second member or to any particular method of securing the first and second members to the hinge assembly. As stated above, the pre-loadable hinge assembly 10 is particularly well suited for “clamshell” devices (not shown) such as laptop computers and personal digital assistants and reference will be made to a laptop computer for purposes of convenience and illustration only and is not intended to be limiting as to application or function of the hinge assembly 10.

Referring now to FIGS. 1 and 2a-2c, the hinge assembly includes a friction element 12 for being secured to the first member. The friction element 12 includes a generally cylindrical wall 14 having a generally longitudinally extending face 16. In the preferred embodiment, the face 16 includes a recess 18, the purpose of which will be discussed below. The wall 14 further includes an internal surface 20 defining a first diameter 22. The friction element 12 preferably includes a torque arm 24 extending from the friction element 12 and configured to be positioned on the first member. In the preferred embodiment, the torque arm 24 is positioned on the wall 14 and preferably extends tangentially outwardly from the wall 14. Those skilled in the art will recognize upon reading this disclosure that the friction element 12 need not have a torque arm 24, but may be attached directly to the first member by other structural arrangements (not shown) well known to those skilled in the art. Further, the torque arm 24 need not extend tangentially from the wall 14, but may extend outwardly at virtually any angle. The torque arm 24 preferably is sufficiently long to accommodate mounting features in the form of holes 26 in the preferred embodiment, and to accommodate a certain amount of bend along its length, as shown in FIG. 2b and as will be discussed more fully below. Due to this bending, the purpose of which will be discussed below, the friction element 12 is preferably made from a resilient material such as spring steel so as to permit the friction element 12, and more particularly, the wall 14 and the torque arm 24, to bend to a certain degree without breaking or fatiguing after many bending cycles. Other materials that may be used include relatively rigid yet tough polymeric materials, including reinforced polymeric materials.

The hinge assembly 10 further includes a generally cylindrical pintle 26 for being secured to the second member. The pintle 26 is rotatably positioned within the friction element 12 and includes an external surface 28 that defines a second diameter 30. The first and second diameters 22, 30 are configured to provide an interference fit therebetween such that the friction element 12 applies a generally radially directed compressive force F to the pintle 26. The compressive force F preferably provides torque transfer and angular positional control of the pintle 26 with respect to the friction element 12. In the preferred embodiment the pintle 26 is made from steel, but other tough, rigid materials may be used without departing from the sprit and scope of the invention.

As best shown in FIGS. 2a-2c, at least one of the internal surface 20 and external surface 28 preferably includes at least one longitudinal groove 31 therein for retaining a lubricant 33, thus greatly increasing the life of the hinge assembly. Referring to FIG. 1, the pintle 26 preferably has a first end 35 for attachment to the second member, the first end 35 having a mounting tab 37 configured to be fixedly attached to the second member via holes 39 and fasteners (not shown). It should be noted that virtually any structure known to those skilled in the art may be used to fix the pintle 26 to the second member, the selection merely being a matter of design choice. For example, instead of the tab 37, the pintle 26 could include a splined connection (not shown). In the preferred embodiment, the mounting tab 37 is oriented generally perpendicular to a longitudinal axis 40 of the pintle 26, but may be oriented otherwise, such as axially (i.e., co-axially with the longitudinal axis 40) without departing from the spirit and scope of the invention.

A protuberance 32 extends generally radially outwardly from the pintle 26 and engages the generally longitudinally extending face 16 of the wall 14 when the pintle 26 and friction element 12 achieve a first predefined angular relationship shown in FIG. 2a. Referring again to FIGS. 1 and 2a-c, the protuberance 32 is shown in the form of a pin, but as those skilled in the art will recognize from reading this disclosure, the protuberance 32 need not be a pin, but could be virtually any other structure that permits rotation of the pintle 26 vis-a-vis the friction element 12 to be impeded by contact between a structure on the pintle 26 and a portion of the friction element 12. For example, the generally longitudinally extending face 16 (or other structural feature on the wall 14) could be engaged by a structure (not shown) on the pintle 26 external to or outboard of the intersecting region of the pintle 26 and wall 14. Alternatively, the friction element 12 could be engaged by a feature on the second member (to which the pintle 26 is fixedly attached), thereby achieving the necessary contact between the pintle 26 and friction element 12 to impede relative rotation therebetween.

Referring to FIGS. 2a-2c, as discussed above the generally longitudinally extending face 16 of the wall 14 includes a recess 18, the purpose of which is to receive the protuberance 32 upon the pintle 26 and friction element 12 achieving the first predefined angular relationship shown in FIG. 2a. In the preferred embodiment, the pintle 26 includes a generally radially oriented hole 40 into which the protuberance 32 is fixedly positioned, the protuberance 32 extending generally radially therefrom a distance sufficient to engage and displace (as discussed below) the generally longitudinally extending face 16. The protuberance 32 is preferably retained within the hole 40 by an interference fit between the protuberance 32 and the hole 40. It will be recognized by those skilled in the art, upon reading this disclosure, that the protuberance 32 need not be situated in a hole 40, but may be unitary with the pintle 26, or may be fixed to the external surface 28 of the pintle 26.

As best shown in FIG. 1, and with secondary reference to FIGS. 2a-2c, the hinge assembly 10 of the preferred embodiment includes an elongated, partial circumferential passage 34 through the wall 14 of the friction element 12. The protuberance 32 preferably is positioned longitudinally on the pintle 26 so as to be in longitudinal alignment and in registry with the partial circumferential passage 34. The pintle 26 and friction element 12 are arranged so the protuberance 34 extends through the partial circumferential passage 34 through at least a portion of a rotational range of motion of the pintle 26 with respect to the friction element 12. In the preferred embodiment, the recess 18 and partial circumferential passage 34 are configured such that the pintle 26 is, at all angular relationships between the pintle 26 and friction element 12, longitudinally constrained with respect to the friction element 12 by interaction of the protuberance 32 and at least one of the partial circumferential passage 34 and the recess 18. As will be recognized by those skilled in the art upon reading this disclosure, alternative mechanisms may be used to longitudinally position the pintle 26 with respect to the friction element 12. For example, longitudinal positioning may be achieved through structures incorporated into the first and second members themselves, or a pair of opposing hinge assemblies, each having inboard or outboard engagement mechanisms (not shown).

Upon relative rotational movement of the pintle 26 and friction element 12 beyond the first predefined angular relationship shown in FIG. 2a to a second predefined angular relationship shown in FIG. 2b, the first diameter 22 is caused to increase due to the force exerted by the protuberance 32 on the generally longitudinally extending face 16. The increase in the first diameter 22 causes outward deflection of the wall 14 resulting in the creation of an end gap 34, thereby decreasing the compressive forces F on the pintle 26. The expansion of the first diameter 22 caused by the radially outward deflection of the generally longitudinally extending face 16 of the wall 14 thus imparts a counter-rotational force to the pintle 26 and friction element 12 (via the protuberance 32) for urging the pintle 26 and friction element 12 away from the second predefined angular relationship shown in FIG. 2b.

Referring still to FIG. 2b, a supplemental force for urging the pintle 26 and friction element 12 away from the second predefined angular relationship is generated by permitting deflection in the torque arm 24. In particular, as the pintle 26 and friction element 12 move from the first predefined angular relationship (FIG. 2a) to the second predefined angular relationship (FIG. 2b), the torque arm 24 deflects or bends to create an angle of bending “d.” Thus, when the pintle 26 and friction element 12 are in the second predefined angular position (FIG. 2b), they are being urged in a rotational direction opposite movement from the first predefined angular position (FIG. 2a) to the second predefined angular position (FIG. 2b) by the radially directed compressive force F of the outwardly deflected wall 14, as shown in FIG. 2b, and by the deflected torque arm 24. Note that in addition to the end gap 34 created by radially outward deflection of the wall 14, deflection of the torque arm 24 causes the creation of a torque-arm gap 36. Creation of one or both of these gaps 34, 36, depending on the configuration of the hinge assembly 10, reduces or eliminates the generally radially directed compressive forces F applied to portions of the external surface 28 of the pintle 26, thereby reducing friction in the hinge assembly that would resist the counter-rotational force urging the pintle 26 and friction element 12 away from the second predefined angular relationship (FIG. 2b).

Preferably, the degree of spring-back from the deflection in the friction element 12 including the torque arm 24 would cause the first and second members to rotationally displace by approximately five degrees, although any other amount of spring back could be pre-configured in the hinge assembly 10 without departing from the spirit and scope of the invention. Obviously, in most circumstances, the angular amount of spring-back caused by pre-loading the hinge assembly 10 as discussed above (including deflection in the torque arm 24) would be greater than the angular difference between the first and second predefined angular relationship. It is important in configuring the hinge assembly 10 and in particular in selecting materials that the amount of pre-load be taken into account. One must remain safely within the yield limits of the selected material, and must avoid prematurely fatiguing the friction member 12. Methods to select an appropriate material for the friction member 12 and to design the hinge assembly with appropriate levels of pre-load are well known to those of those skilled in the art.

To illustrate the hinge assembly 10 using the example of a laptop computer (not shown), the second predefined angular relationship (FIG. 2b) would equate to the closed position wherein the display panel and keyboard (i.e., first and second members, nonrespectively) are in face-to-face mating engagement, the second predefined angular relationship shown in FIG. 2b. In this position the hinge assembly 10 is storing energy in the form of an outwardly-deflected wall 14 and a bend or deflection in the torque arm 24. Additionally, the radially directed compressive forces F, which normally resist relative rotational movement between the pintle 26 and friction element 12, are reduced or eliminated in portions of the interface between the internal and external surfaces 20, 28. Thus, when the user releases a latch that maintains the first and second members in the closed position, the energy stored in the hinge assembly 10 is released and causes the first and second members to spring apart by a distance determined by the configuration of the hinge assembly 10 and the mass and orientation of the first and/or second members. This springing apart is greatly aided by the reduction in radially directed compressive forces F that result from deflection of the wall 14 and torque arm 24. The first and second members may then manually be opened to the full open position, shown in FIG. 2c where the friction element 12 and pintle 26 achieve the third pre-defined angular relationship (FIG. 2c). To again pre-load the hinge assembly, the user would close the laptop computer, moving the first and second members, and therefore the friction member(s) 12 and pintle(s) 26, rotatingly with respect to one another, moving from the third predefined angular relationship (FIG. 2c), through the first predefined angular relationship (FIG. 2a), to the second predefined angular relationship (FIG. 2b), also imparting a bend to the torque arm 24. In accordance with the above discussion, preferably the first and second members of the laptop computer would spring apart by approximately five degrees, although other angular amounts may be configured.

It will be appreciated by those skilled in the art that changes could be made to the embodiments described above without departing from the broad inventive concept thereof. For example, the hinge assembly 10 could be configured to provide a lesser degree of stored energy by eliminating the torque arm 24, merely attaching the first member to the wall 14 or other suitable point of attachment. It is understood, therefore, that this invention is not limited to the particular embodiments disclosed, but it is intended to cover modifications within the spirit and scope of the present invention as defined by the appended claims.

I/we claim:

1. A hinge assembly for rotatably coupling a first member to a second member, said assembly comprising:
a friction element for being secured to the first member, the friction element having a generally cylindrical wall, the wall having a generally longitudinally extending face and an internal surface defining a first diameter;
a generally cylindrical pintle for being secured to the second member and being rotatably positioned within the friction element, the pintle including an external surface, the external surface defining a second diameter, the first and second diameters being configured to provide an interference fit therebetween such that the friction element applies a generally radially directed compressive force to the pintle; and
a protuberance extending generally radially outwardly from the pintle, the protuberance engaging the generally longitudinally extending face when the pintle and friction element achieve a first predefined angular relationship with respect to one another, movement beyond the first predefined angular relationship to a second predefined angular relationship between the friction member and pintle causing the first diameter to increase, thereby decreasing the compressive forces to the pintle and imparting a counter-rotational force to the pintle and friction element for urging the pintle and friction element away from the second predefined angular relationship.

2. The hinge assembly of claim 1 further including a torque arm extending from the friction element and configured to be positioned on the first member, the torque arm deflecting as the pintle and friction element move from the first to the second predefined angular relationship, the deflection providing a supplemental force for urging the pintle and friction element away from the second predefined angular relationship.

3. The hinge assembly of claim 1 further including an elongated, partial circumferential passage through wall of the friction element, the protuberance positioned longitudinally on the pintle so as to be in longitudinal alignment and registry with the partial circumferential passage, the pintle and friction element being arranged so the protuberance extends through the partial circumferential passage through at least a portion of a rotational range of motion of the pintle with respect to the friction element.

4. The hinge assembly of claim 3 wherein at least one of the internal surface and external surface includes at least one longitudinal groove therein for retaining a lubricant therein.

5. The hinge assembly of claim 4 wherein the pintle has a first end for attachment to the second member, the first end having a mounting tab configured to be fixedly attached to the second member.

6. The hinge assembly of claim 5 wherein the mounting tab is generally perpendicular to a longitudinal axis of the pintle.

7. The hinge assembly of claim 1 wherein the generally longitudinally extending face includes a recess for receiving the protuberance upon the pintle and friction element substantially achieving the first predefined angular relationship.

8. The hinge assembly of claim 7 wherein the recess and partial circumferential passage are configured such that the pintle is, at all angular relationships between the pintle and friction element, longitudinally constrained with respect to the friction element by interaction of the protuberance and at least one of the partial circumferential passage and the recess.

9. The hinge assembly of claim 1 wherein the pintle includes a generally radially oriented hole and the protuberance is fixedly positioned in the hole and extends generally radially therefrom.

10. The hinge assembly of claim 1 wherein the compressive force provides torque transfer and angular positional control of the pintle with respect to the friction element.

11. A hinge assembly for rotatably coupling a first member to a second member, said assembly comprising:
a friction element for being secured to the first member, the friction element having a generally cylindrical wall, the wall having a generally longitudinally extending face and an internal surface defining a first diameter;
a generally cylindrical pintle for being secured to the second member and being rotatably positioned within the friction element, the pintle including an external surface, the external surface defining a second diameter, the first and second diameters being configured to provide an interference fit therebetween such that the friction element applies a generally radially directed compressive force to the pintle;
a protuberance extending generally radially outwardly from the pintle, the protuberance engaging the longitudinally extending face when the pintle and friction element achieve a first predefined angular relationship with respect to one another, movement beyond the first predefined angular relationship to a second predefined angular relationship between the friction member and pintle causing the first diameter to increase, thereby decreasing the compressive forces to the pintle and imparting a counter-rotational force to the pintle and friction element for urging the pintle and friction element away from the second predefined angular relationship; and
a torque arm extending from the friction element and configured to be positioned on the first member, the torque arm deflecting as the pintle and friction element move from the first to the second predefined angular relationship, the deflection providing a supplemental force for urging the pintle and friction element away from the second predefined angular relationship.

12. A hinge assembly for rotatably coupling a first member to a second member, said assembly comprising:
a friction element for being secured to the first member, the friction element having a generally cylindrical wall, the wall having a generally longitudinally extending face and an internal surface defining a first diameter and an elongated, partial circumferential passage through wall;
a generally cylindrical pintle for being secured to the second member and being rotatably positioned within the friction element, the pintle including an external surface, the external surface defining a second diameter, the first and second diameters being configured to provide an interference fit therebetween such that the friction element applies a generally radially directed compressive force to the pintle;
a protuberance extending generally radially outwardly from the pintle, the protuberance engaging the generally longitudinally extending face when the pintle and friction element achieve a first predefined angular relationship with respect to one another, movement beyond the first predefined angular relationship to a second predefined angular relationship between the friction member and pintle causing the first diameter to increase, thereby decreasing the compressive forces to the pintle and imparting a counter-rotational force to the pintle and friction element for urging the pintle and friction element away from the second predefined angular relationship, the protuberance positioned longitudinally on the pintle so as to be in longitudinal alignment and registry with the partial circumferential passage, the pintle and friction element being arranged so the protuberance extends through the partial circumferential passage through at least a portion of a rotational range of motion of the pintle with respect to the friction element; and
a torque arm extending from the friction element and configured to be positioned on the first member, the torque arm deflecting as the pintle and friction element move from the first to the second predefined angular relationship, the deflection providing a supplemental force for urging the pintle and friction element away from the second predefined angular relationship.
